(19) United States
(12) Patent Application Publication
(10) Pub. No.: US 2011/0202964 A1
(43) Pub. Date: Aug. 18, 2011

(54) TELEVISION BROADCASTING RECEIVER

(75) Inventor: Toshiaki Mizushima, Osaka (JP)

(73) Assignee: SANYO ELECTRIC CO., LTD., Osaka (JP)

(21) Appl. No.: 13/027,627

(22) Filed: Feb. 15, 2011

(30) Foreign Application Priority Data
Feb. 16, 2010 (JP) 2010-031357

(51) Int. Cl. H04N 7/173

(52) U.S. Cl. 725/100

(57) ABSTRACT

A television broadcasting receiver includes a function of the Internet connection, and a display signal generating unit. The display signal generating unit generates a display signal for displaying information about content that is provided by a VOD service and is the same as or similar to the television broadcasting program that is being viewed.

### CROSS-REFERENCE TO RELATED APPLICATIONS

This nonprovisional application claims priority under 35 U.S.C. §119(a) on Patent Application No. 2010-031357 filed in Japan on Feb. 16, 2010, the entire contents of which are hereby incorporated by reference.

### BACKGROUND OF THE INVENTION

1. Field of the Invention

The present invention relates to a television broadcasting receiver, particularly to a television broadcasting receiver having a function of the Internet connection so as to reproduce contents of Video On Demand (VOD) service obtained via the Internet. Note that the television broadcasting receiver includes not only a television receiving set but also a set top box (STB) without a monitor unlike the television receiving set, or an electrical apparatus that is not specialized for receiving television broadcasting (e.g., a personal computer including a television tuner) unlike the television receiving set.

2. Description of Related Art

There are already commercialized television broadcasting receivers having not only the normal television receiving function but also a function of the Internet connection so as to reproduce contents of the VOD service obtained via the Internet.

The VOD service is provided by a specific content provider in a pay broadcast system as a rule. The rate system thereof is usually an annual or monthly fixed rate system, or a charging system per content unit that is called “pay per view”. In addition, the individual VOD services provided by individual content providers have their unique contents. Further, the same television broadcasting receiver can receive a plurality of VOD services from different content providers.

When the user started to view a television broadcasting program from halfway, the user may want to view the program from the beginning. In addition, the user may want to view the same content at a higher resolution than the television broadcasting program that is usually broadcasted at a low resolution. In addition, the user may want to view the same content without commercials instead of the television broadcasting program that is provided with commercials in many cases.

The same or similar content to the television broadcasting program that is being viewed may be available by the VOD service. In that case, the user can view the content instead of viewing the television broadcasting program so as to satisfy his or her desire described above. Despite this, the user cannot know easily whether or not the content is provided by the VOD service.

### SUMMARY OF THE INVENTION

A television broadcasting receiver according to the present invention has a function of the Internet connection, and includes a display signal generating unit. The display signal generating unit generates a display signal for displaying information about content that is provided by a VOD service and is the same as or similar to the television broadcasting program that is being viewed.

Meanings and effects of the present invention will be apparent from the description of the embodiments given below. However, the embodiments described below are merely examples of the present invention, and meanings of terms in the present invention and each structural element are not limited to those described in the following embodiments.

### BRIEF DESCRIPTION OF THE DRAWINGS

FIG. 1 is a diagram illustrating a structure of a television receiving set according to a first embodiment of the present invention.

FIG. 2 is a flowchart illustrating an action of the television receiving set according to the first embodiment of the present invention.

FIG. 3 is a diagram illustrating a display screen example of a display of the television receiving set according to the first embodiment of the present invention.

FIG. 4 is a flowchart illustrating an action of a television receiving set according to a second embodiment of the present invention.

### DETAILED DESCRIPTION OF THE PREFERRED EMBODIMENTS

Embodiments of the present invention are described below with reference to the attached drawings. As a television broadcasting receiver according to the present invention, a television receiving set is exemplified here for the description.

### First Embodiment

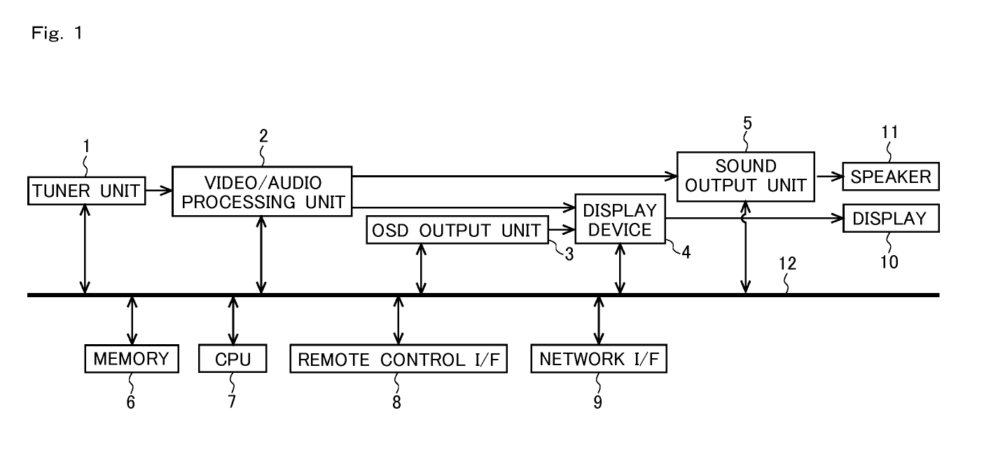

First, a television receiving set according to a first embodiment of the present invention is explained. A structure of the television receiving set according to the first embodiment of the present invention is illustrated in FIG. 1. The television receiving set according to the first embodiment of the present invention includes a tuner unit 1, a video/audio processing unit 2, an OSD output unit 3, a display device 4, a sound output unit 5, a memory 6 which stores a control program and video, sound, and other data, a CPU 7 which controls the entire television receiving set, a remote control I/F 8 which receives a signal transmitted from a remote control transmitter, a network I/F 9 for connecting to the Internet, a display 10, a speaker 11, and a bus 12. The tuner unit 1, the video/audio processing unit 2, the OSD output unit 3, the display device 4, the sound output unit 5, the memory 6, the remote control I/F 8, and the network I/F 9 are connected to the CPU 7 via the bus 12.

When the user holds the remote control transmitter (not shown) toward the television receiving set according to the first embodiment of the present invention in the power off state and presses a power key of the remote control transmitter (not shown), a power switching signal is transmitted from the remote control transmitter (not shown) to the television receiving set according to the first embodiment of the present invention in the power off state. Thus, the remote control I/F 8 receives the power switching signal so that the television receiving set according to the first embodiment of the present invention becomes the power on state.

Then, being the power on state, the CPU 7 controls to perform the following action in accordance with the control program stored in the memory 6.

The tuner unit 1 selects a television broadcasting signal of a channel frequency corresponding to a set analog channel or digital channel among received television broadcasting signals. The selected signal is down-converted and is output to the video/audio processing unit 2. Further, if the user changed the selected channel by operating a key of the remote control transmitter (not shown), the remote control I/F 8 receives a signal about the change of the selected channel, and the CPU 7 controls the tuner unit 1 to change the selection for tuning on the basis of the signal received by the remote control I/F 8.

The video/audio processing unit 2 generates a video signal and a sound signal from an output signal of the tuner unit 1, so as to deliver the video signal to the display device 4 and to deliver the sound signal to the sound output unit 5. In addition, the video/audio processing unit 2 performs a video/audio process on streaming data that is transmitted from a server (not shown) of a content provider providing a VOD service and is received by the network I/F 9 for buffering in the memory 6. Thus, the video signal and the sound signal are generated, so that the video signal is delivered to the display device 4 while the sound signal is delivered to the sound output unit 5.

The OSD output unit 3 generates an OSD signal on the basis of an instruction from the CPU 7, and delivers the OSD signal to the display device 4.

The display device 4 delivers the video signal delivered from the video/audio processing unit 2, the OSD signal delivered from the OSD output unit 3, or a signal including the video signal delivered from the video/audio processing unit 2 on which the OSD signal delivered from the OSD output unit 3 is superposed, to the display 10 and/or an external video output terminal (not shown).

After performing a process of amplification or the like, or without performing any process on the sound signal delivered from the video/audio processing unit 2, the sound output unit 5 delivers the signal to the speaker 11 and/or an external sound output terminal (not shown).

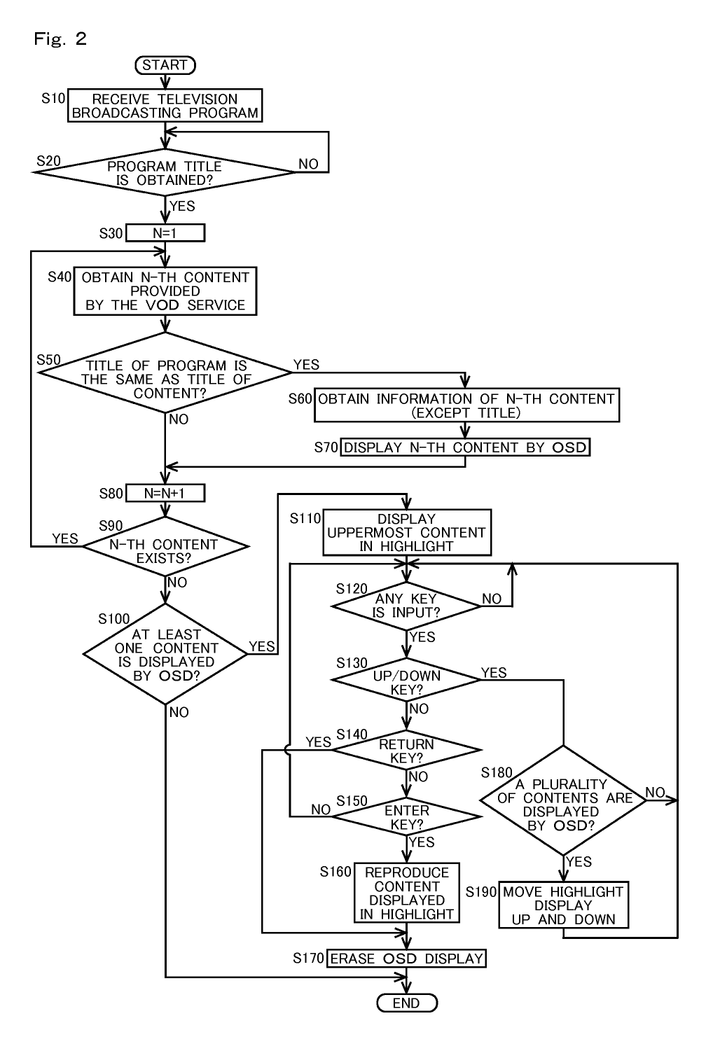

Next, the characteristic action of the television receiving set according to the first embodiment of the present invention, namely the action of searching for the same or similar content to the television broadcasting program that is being viewed, which is available by the VOD service, displaying the search result by OSD, and displaying the content to view, is described with reference to the flowchart illustrated in FIG. 2.

At each timing when the power is turned on, when the viewing channel is changed, or when the program is changed in the same viewing channel, the flowchart illustrated in FIG. 2 starts. Note that the change of program in the same viewing channel can be decided by the CPU 7 having a clock function on the basis of an electronic program guide (EPG). In addition, if the viewing channel is an analog channel, the CPU 7 can decide on the basis of program title data contained in the television broadcasting signal selected by the tuner unit 1. The data of the electronic program guide may be obtained from the television broadcasting signal received by the tuner unit 1 so as to be stored in the memory 6, or may be obtained from the server (not shown) providing the data of the electronic program guide via the network I/F 9 so as to be stored in the memory 6.

In Step S10, a television broadcasting program is received on the basis of predetermined channel setting or channel setting selected by the user, so that video and sound of the received television broadcasting program are output. After that, the process flow goes to Step S20.

In Step S20, acquisition of program title data of the television broadcasting program that is being viewed is tried. If the acquisition is failed (NO in Step S20), the process stays on Step S20. If the acquisition is succeeded (YES in Step S20), the process flow goes to the next Step S30. Note that as the method of obtaining the program title data, for example, there is a method in which the CPU 7 having a clock function obtains the program title data of the television broadcasting program that is being viewed from the electronic program guide (EPG), or a method in which the CPU 7 obtains the program title data contained in the television broadcasting signal selected by the tuner unit 1 if the viewing channel is an analog channel, for example.

In Step S30, a variable N is initialized to be 1, and the process flow goes to the next Step S40. Note that the variable N indicates an ordinal number of the contents that is provided by the VOD service and is being viewed at present, which is stored in the memory 6.

In Step S40, the title of the N-th content provided by the VOD service is obtained via the network I/F 9 from the server (not shown) of the content provider providing the VOD service, and the process flow goes to the next Step S50. Note that the VOD service may be a single VOD service or a plurality of VOD services.

In Step S50, it is decided whether or not the title of the N-th content obtained in Step S40 is the same as the title of the television broadcasting program that is being viewed. If they are the same (YES in Step S50), the process flow goes to Step S60. If they are not the same (NO in Step S50), the process flow goes to Step S80. The decision in Step S50 that they are the same may be made not only in the case where the character strings of them are strictly identical but also in the case where the character strings of them are partially the same.

In Step S60, information of the N-th content about content length, image quality, price, content provider name, and comments is obtained from the server (not shown) of the content provider providing the VOD service via the network I/F 9, and the process flow goes to the next Step S70.

In Step S70, the title of the N-th content obtained in Step S40 and the information about content length, image quality, price, content provider name, and comments obtained in Step S60 are displayed by OSD. If there are existing content that is already displayed, the additional display is performed under it. After that, the process flow goes to Step S80.

In Step S80, the variable N is incremented by 1, and the process flow goes to the next Step S90.

In Step S90, it is decided whether or not the N-th content exists. If the N-th content exists (YES in Step S90), the process flow goes back to Step S40. If the N-th content does not exist (NO in Step S90), the process flow goes to Step S100.

In Step S100, it is decided whether or not at least one content is already displayed by OSD. If at least one content is already displayed by OSD (YES in Step S100), the process flow goes to Step S110. If no content is displayed by OSD (NO in Step S100), the process flow is finished.

In Step S110, the uppermost content is displayed in highlight so as to indicate the user that the content is selected. Note that if only one content is displayed by OSD, the content is displayed in highlight. After that, the process flow goes to Step S120.

In Step S120, the process flow waits until the user performs an input of any key using the remote control transmitter (not shown). If any key is input (YES in Step S120), the process flow goes to Step S130. If no key is input (NO in Step S120), the process stays on Step S120.

In Step S130, it is decided whether or not the key input in Step S120 corresponds to an up/down key. If it corresponds to the up/down key (YES in Step S130), the process flow goes to Step S180. If it does not correspond to the up/down key (NO in Step S130), the process flow goes to Step S140.

In Step S140, it is decided whether or not the key input in Step S120 corresponds to a return key. If it corresponds to the return key (YES in Step S140), the process flow goes to Step S170. If it does not correspond to the return key (NO in Step S140), the process flow goes to Step S150.

In Step S150, it is decided whether or not the key input in Step S120 corresponds to an enter key. If it corresponds to the enter key (YES in Step S150), the process flow goes to Step S160 in which the selection is confirmed. If it does not correspond to the enter key (NO in Step S150), the process flow goes back to Step S120.

In Step S160, reproduction of the content displayed in highlight is started, and after that the process flow goes to Step S170.

In Step S170, the OSD display is erased, and after that the process flow is finished.

In Step S180, it is decided whether or not a plurality of contents are displayed by OSD. If a plurality of contents are displayed by OSD (YES in Step S180), the process flow goes to Step S190. If a plurality of contents are not displayed by OSD (NO in Step S180), the process flow goes back to Step S120.

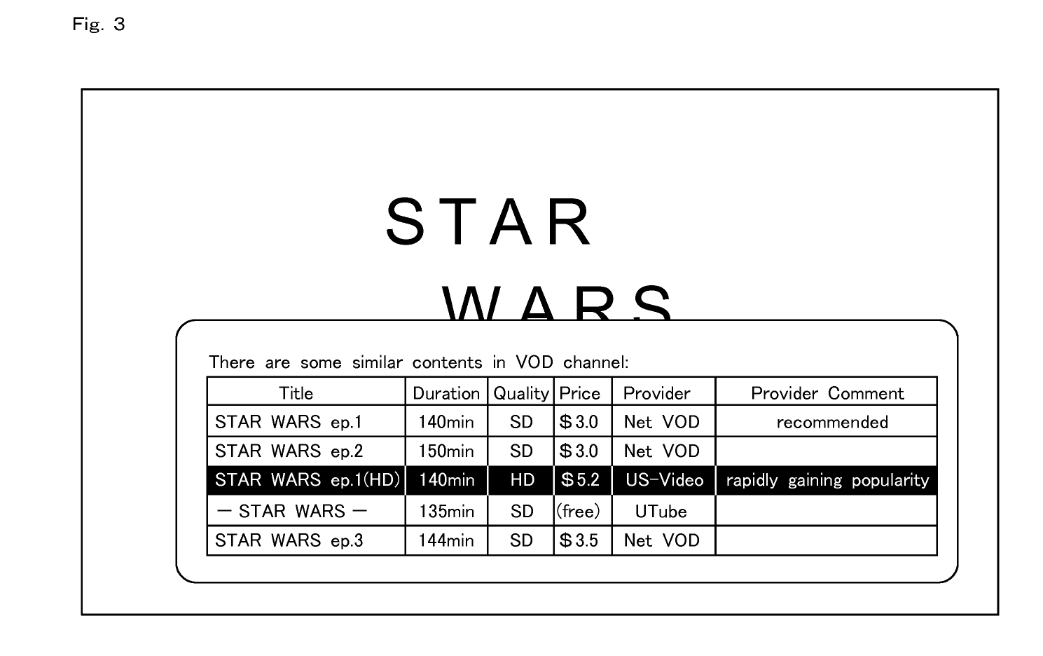

Here, a display screen example of the display 10 after the process in Step S190 is performed is illustrated in FIG. 3.

In the display screen example illustrated in FIG. 3, the video of the television broadcasting program that is being viewed is displayed on the background of the screen, on which the information about the content of the VOD service having the same title as the television broadcasting program that is being viewed is display by OSD in a list form so as to be superposed. The information about one content is constituted of a title (Title), content length (Duration), image quality (Quality), price (Price), a name of the content provider providing this program (Provider), and a comment from the content provider (Provider Comment).

As apparent from the flowchart illustrated in FIG. 2, the user can select one content from the list displayed by OSD (see FIG. 3) by the remote control operation, so as to view the content of the VOD service substituting for the television broadcasting program that is being viewed, namely, the content that is the same as or similar to the television broadcasting program that is being viewed. Therefore, the television receiving set according to the first embodiment of the present invention can support the user to select a desired content of the VOD service.

In addition, as apparent from the flowchart illustrated in FIG. 2, if the viewer does not want to view the content in the list displayed by OSD (see FIG. 3) and continues to view the television broadcasting program that is being viewed, the viewer can delete the OSD display by pressing the return key of the remote control transmitter (not shown), so as to continue to view the television broadcasting program that is being viewed.

### Second Embodiment

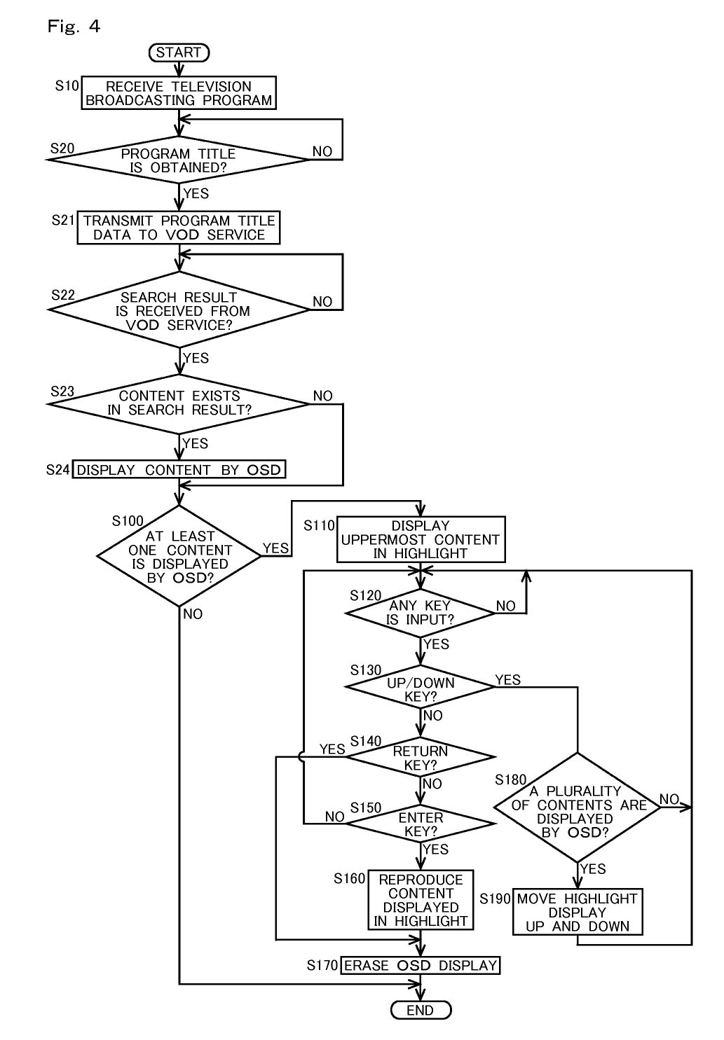

Next, a television receiving set according to a second embodiment of the present invention is described. The television receiving set according to the second embodiment of the present invention has the structure illustrated in FIG. 1 similarly to the television receiving set according to the first embodiment of the present invention. However, the television receiving set according to the second embodiment of the present invention performs the action of the flowchart illustrated in FIG. 4 instead of the action of the flowchart illustrated in FIG. 2.

In FIG. 4, the same step as in FIG. 2 is denoted by the same symbol so that detailed description thereof is omitted. As to the flowchart illustrated in FIG. 4, Steps S40 to S90 in the flowchart illustrated in FIG. 2 are eliminated, and instead, Steps S21 to S24 are added.

In Step S21, information of the program title obtained in Step S20 is transmitted via the network I/F 9 to the server (not shown) of the content provider providing the VOD service. The server (not shown) of the content provider providing the VOD service searches for content of the same title as the received program title among the contents provided by the content provider. If there is no content of the same title, the fact is transmitted as the search result to the television receiving set according to the second embodiment of the present invention. If there is content of the same title, information about title name, content length, image quality, price, content provider name, and comment of the content is transmitted as the search result to the television receiving set according to the second embodiment of the present invention. Further, also in this embodiment, similarly to the first embodiment, the decision that the titles are the same may be made not only in the case where the character strings of them are strictly identical but also in the case where the character strings of them are partially the same.

In Step S22, it is decided whether or not the search result is received from the server (not shown) of the content provider providing the VOD service via the network I/F 9. If the search result is received (YES in Step S22), the process flow goes to the next Step S23. If the search result is not received (NO in Step S22), the process stays on Step S22.

In Step S23, it is decided whether or not the search result received in Step S22 contains information of the content. If the information of the content is contained (YES in Step S23), the information about title name, content length, image quality, price, content provider name, and comment of the content received in Step S22 is displayed by OSD in a list form (Step S24), and after that, the process flow goes to Step S100. On the contrary, if the information of the content is not contained (NO in Step S23), the process flow goes directly to Step S100.

Further, also in this embodiment, similarly to the first embodiment, the display screen example of the display 10 after the process of Step S190 is performed is as illustrated in FIG. 3.

As apparent from the flowchart illustrated in FIG. 4, the user can select one content from the list displayed by OSD (see FIG. 3) by the remote control operation, so as to view the content of the VOD service substituting for the television broadcasting program that is being viewed, namely, the content that is the same as or similar to the television broadcasting program that is being viewed. Therefore, the television receiving set according to the second embodiment of the present invention can support the user to select a desired content of the VOD service.

In addition, as apparent from the flowchart illustrated in FIG. 4, if the viewer does not want to view the content in the list displayed by OSD (see FIG. 3) and continues to view the television broadcasting program that is being viewed, the viewer can erase the OSD display by pressing the return key of the remote control transmitter (not shown), so as to continue to view the television broadcasting program that is being viewed.

### Variation Examples

Although the embodiments of the present invention are described above, the scope of the present invention is not limited to them, which can be modified variously within the scope without deviating from the spirit of the invention. Some of the variation examples are described below.

In the embodiment described above, if there is the content of the VOD service having the same title as the television broadcasting program that is being viewed at each timing when the power is turned on, when the viewing channel is changed, or when the program is changed in the same viewing channel, information about the content is always displayed by OSD. However, there is a case where such an OSD display is not necessary. Therefore, it is possible to provide a new step between Step S10 and Step S20, for example, in which it is decided whether or not the user did a specific key operation. If the specific key operation was performed, the process flow goes to Step S20. If the specific key operation was not performed, the process stays on the newly provided step. Alternatively, it is possible to provide a mode in which Step S20 and subsequent steps are performed, and another mode in which Step S20 and subsequent steps are not performed, for example, so that the user can select one of the modes by a key operation.

In addition, there may be a user who feels it is burdensome that the OSD display is superposed on the main video of the television broadcasting program while viewing the television broadcasting program. Therefore, it is possible to adopt a structure in which a function of detecting commercials is provided, so that the OSD display is superposed only on commercial videos and is not superposed on the main video of the television broadcasting program. As the function of detecting commercials, a known commercial detection technique can be used. As the known commercial detection technique, for example, there is known a technique of detecting commercials on the basis of a sound output of the television broadcasting program.

In addition, in the first embodiment described above, the content having the same title as the title of the television broadcasting program that is being viewed is displayed by OSD one by one in Step S70. But, there may be a user who feels it is burdensome to display by OSD until the list is completed. Therefore, it is possible to adopt a structure in which Step S70 is eliminated, and instead, a new step is added between Step S90 and Step S100 for displaying by OSD all the contents having the same title as the title of the television broadcasting program that is being viewed.

In addition, in the embodiment described above, the search result is displayed by OSD in the searched order. Instead of this, the search result may be displayed by OSD in the arrangement order based on a specific item of information about the content. For instance, if the specific item is set to price (Price), the user can easily perform the selection in which price (Price) of content is regarded as important. Note that the setting of the specific item can preferably be changed by the user's key operation. In addition, the specific item may be a single item or may be a combination of a plurality of items. In addition, it is possible to provide a mode in which the search result is displayed by OSD in the searched order and another mode in which the search result is displayed by OSD in the arrangement order based on a specific item of information about the content, so that the user can select one of the modes by key operation.

In addition, in the embodiment described above, the content having the same title as the title of the television broadcasting program that is being viewed is searched for, but instead of this, it is possible to search for content having the same performer information as the television broadcasting program that is being viewed so as to extract also content having a relatively weak relationship with the television broadcasting program that is being viewed. On the contrary, it is possible to search for content having the same title and the same performer information as the television broadcasting program that is being viewed so as to extract content having a relatively strong relationship with the television broadcasting program that is being viewed. Further, as the method of obtaining performer information of the television broadcasting program that is being viewed, for example, there is considered a method in which the CPU 7 having a clock function obtains the performer information of the television broadcasting program that is being viewed from the electronic program guide (EPG). In addition, the decision that the performer information sets are the same may be made not only in the case where the character strings of them are strictly identical but also in the case where the character strings of them are partially the same.

In addition, the first embodiment and the second embodiment may be combined. Specifically, it is possible to perform the search on the television broadcasting receiver side for contents provided by the VOD service and to perform the search on the VOD service side for contents provided by another VOD service.

What is claimed is:

1. A television broadcasting receiver comprising:
a function of the Internet connection; and
a display signal generating unit, wherein
the display signal generating unit generates a display signal for displaying information about content that is provided by a VOD service and is the same as or similar to the television broadcasting program that is being viewed.

2. A television broadcasting receiver according to claim 1, further comprising:
a selecting unit; and
a content reproducing unit, wherein
the selecting unit selects one content from contents that are provided by the VOD service and is the same as or similar to the television broadcasting program that is being viewed, and wherein
the content reproducing unit reproduces the content selected by the selecting unit.

3. A television broadcasting receiver according to claim 1, wherein the display signal generating unit includes
a television broadcasting program information obtaining unit which obtains a title and/or performer information of the television broadcasting program that is being viewed,
a searching unit which searches for content having the same title and/or the same performer information as the title and/or the performer information of the television broadcasting program that is being viewed, obtained by the television broadcasting program information obtaining unit, from the contents provided by the VOD service, and
a contents information obtaining unit which obtains information about the content extracted in the search by the searching unit.

4. A television broadcasting receiver according to claim 3, wherein the same title and/or the same performer information mean not only the completely identical ones but also partially the same ones.

5. A television broadcasting receiver according to claim 3, wherein the searching unit performs the search at each timing when power is turned on, when a viewing channel is changed, or when a television broadcasting program is changed in the same viewing channel.

6. A television broadcasting receiver according to claim 1, wherein the display signal generating unit includes
a television broadcasting program information obtaining unit which obtains a title and/or performer information of the television broadcasting program that is being viewed,
a transmitting unit which transmits the title and/or the performer information of the television broadcasting program that is being viewed, obtained by the television broadcasting program information obtaining unit, to a server of a content provider providing the VOD service via the Internet, and
a receiving unit which receives information about the content having the same title and/or the same performer information as the title and/or the performer information of the television broadcasting program that is being viewed, obtained by the obtaining unit, from the server via the Internet.

7. A television broadcasting receiver according to claim 6, wherein the same title and/or the same performer information mean not only the completely identical ones but also partially the same ones.

8. A television broadcasting receiver according to claim 6, wherein the transmitting unit performs the transmission at each timing when power is turned on, when a viewing channel is changed, or when a television broadcasting program is changed in the same viewing channel.

9. A television broadcasting receiver according to claim 1, further comprising a function of detecting commercials, wherein the display signal is superposed only on commercial video signals of the television broadcasting program that is being viewed, and is not superposed on a main video signal of the television broadcasting program that is being viewed.

10. A television broadcasting receiver according to claim 1, wherein
the information about content is constituted of a plurality of items, and
the display signal is a signal for displaying information about contents that are the same as or similar to the television broadcasting program that is being viewed, in a list of an arrangement order based on a specific item in the plurality of items.
